(19) United States
(12) Patent Application Publication
(10) Pub. No.: US 2022/0261203 A1
(43) Pub. Date: Aug. 18, 2022

(54) NETWORKS OF DISPLAY DEVICES AND METHOD OF POWERING THE DEVICES ON AND OFF

(71) Applicant: VESTEL ELEKTRONIK SANAYI VE TICARET A.S., Manisa (TR)

(72) Inventor: Ismail YILMAZLAR, Manisa (TR)

(21) Appl. No.: 17/625,605

(22) PCT Filed: Jul. 24, 2019
(86) PCT No.: PCT/EP2019/069937

§ 371 Date: Jan. 7, 2022

(51) Int. Cl. G06F 3/14; G06F 1/3234; G06F 1/3287

(52) U.S. Cl. CPC G06F 3/1431; G06F 1/3287; G06F 1/3265

(57) ABSTRACT

Powering on a plurality of display devices is provided, wherein each of the display devices at least comprises a main processor and a visual display unit under control of the main processor. The approach comprises powering on the main processors of at least a majority of the display devices at a first time, and powering on the visual display units of said majority of the display devices at a later time. Powering down such a plurality of display devices is provided by performing a similar sequence of operations in reverse temporal order. A server connected in communication with a plurality of display devices is configured to power the main processor of at least a majority of the display devices on or off at a different time from powering the visual display unit of the same display devices respectively on or off.

The present invention relates to a method of powering on a plurality of display devices according to claim 1, a method of powering down a plurality of display devices according to claim 7, and a network comprising a plurality of display devices, according to claim 12.

### BACKGROUND OF THE INVENTION

Large public facilities, such as shopping centres, railway stations, airports and the like can contain large numbers of display devices for displaying advertisements, arrival and departure information, maps of the facilities, and so on. Often, these display devices are networked together to display similar or related information at multiple different locations at the same time. Sometimes, at least some of these display devices may also be interactive, allowing a user, for example to identify the locations of food outlets or a particular type of shop within the facility by interaction with a touch screen. Typically, these display devices have a large surface area (for example, 2 square metres or more) and comprise visual display units, such as OLED or plasma display screens, which require high levels of illumination. This is typically provided by a lighting unit, such as a screen backlight, built into the display device. A single one of these display devices can therefore have an electrical power consumption of, for example, 150 watts. Consequently, a large number of such display devices, for example 200 such display devices, can have a combined power consumption of 200×150=30 kW.

This large combined power consumption creates a problem at power-on, for example if the display devices are all powered on simultaneously before the public facility opens in the morning. At such a time, the sudden and large increase in electrical power consumption can create an unacceptably high load on the electrical power distribution network, drawing a high current which the power supply may be unable to cope with, and which can also have an undesirable knock-on effect on other loads attached to the same power distribution network.

Various solutions are therefore known in the prior art to address this problem. One possible solution which has been used is to spread the power-on of the plurality of display devices over a finite time period, for example over 5 minutes, by randomly powering on different ones of the plurality of display devices at different respective times over the finite time period. Although this possible solution has the advantage of spreading the increase in electrical power consumption over a longer period of time, it also carries the risk that a large number of the display devices will still be powered on within a short time of each other, thereby creating an unacceptably high load on the power distribution network and drawing a high current which the power supply may still be unable to cope with.

A second possible solution which has been used, therefore, is not to power-on different ones of the plurality of display devices at different times which are spread randomly over a finite time period, but instead to schedule the power-on of different ones of the plurality of display devices at respectively different selected times spread over the finite time period, wherein the selected times are scheduled according to a unique media access control (MAC) address of a network communications module associated with each respective one of the plurality of display devices. Although this possible solution has the advantage of reducing the risk of overloading the power distribution network, it also has the disadvantage that it can require additional hardware to control power-on of the display devices at different times from each other, which has increased cost, and which may not be suitable for use in all contexts.

A third possible solution which has been used, therefore, is to manually power-on different ones of the plurality of display devices at different respective times spread over a finite time period, for example using a graphical user interface. However, this possible solution has the disadvantages that it carries a risk of human error, as well as increased labour costs.

Accordingly, there is a need for an improved method of powering on a plurality of display devices, such as those found in large public facilities.

### OBJECT OF THE INVENTION

It is therefore an object of the invention to provide a method of powering on a plurality of display devices, a method of powering down a plurality of display devices, and a network comprising a plurality of display devices.

### DESCRIPTION OF THE INVENTION

The object of the invention is solved by a method of powering on a plurality of display devices, according to claim 1. Each of the display devices at least comprises a main processor and a visual display unit under control of the main processor. The main processor may, for example, comprise a central processing unit, which is mounted on a main circuit board of the display device. The method at least comprises powering on the main processors of at least a majority of the display devices at a first time, and powering on the visual display units of said majority of the display devices at a later time.

This solution is beneficial because typically, the main processor of a display device only consumes a small fraction of the total electrical power consumed by the display device, much more of which is consumed by other components of the display device, such as the visual display unit of the device and a lighting unit for illuminating the visual display unit, such as a screen backlight. For example, for a display device which has a total power consumption of 150 watts, the power consumed by the main processor may only be about 5 watts, i.e. less than 10% of the total power consumption of the display device. Thus when the main processors of at least a majority of the plurality of display devices are powered on at the first time, the combined power consumption of the plurality of display devices only rises by a small amount, which is a fraction of the combined total power consumption of the plurality of display devices if they were instead fully powered on at once, as in the prior art.

The visual display units of the majority of the display devices may then each be powered on subsequently, at a time or times, each of which is later than the first time at which the main processors of the display devices are powered on. The load placed on the power distribution network by powering on the plurality of display devices is thereby spread over a finite period of time, reducing the current drawn from the power distribution network, and the strain on the power distribution network is thereby also reduced.

Advantageous embodiments of the invention may be configured according to any claim and/or part of the following description.

In some embodiments, the method may comprise powering on the main processor of all of the display devices at the first time, and powering on the respective visual display units of the plurality of display devices at different respective times, each of which is later than the first time. Whereas powering on the main processor of all of the plurality of display devices at the first time generates an increased power consumption than powering on the main processor of only a majority of the display devices at the first time, since the main processor only consumes a small fraction of the total power consumed by each display device, the power distribution network is easily able to cope with them all being powered on together. On the other hand, this solution has the advantage that the main processors of all of the plurality of display devices can then boot up ready for operation, after which the respective visual display units of the plurality of display devices can be powered on at different respective times to spread the load placed on the power distribution network.

In further embodiments, the method may further comprise, after the first time but before the later time, receiving a notification at a server from at least one of the display devices that the main processor of the at least one of the display devices is booted up, and issuing a command from the server to the at least one of the display devices to power on the visual display unit of the at least one of the display devices. This solution has the advantage that the server can then be sure that the main processor of the at least one of the display devices is ready for operation before powering on the visual display unit of the at least one of the display devices. Preferably, the same method can be applied to at least a majority of the display devices, and more preferably still, the same method can be applied to all of the display devices in the plurality of the display devices.

Alternatively or additionally, in some embodiments, the method may comprise powering on the visual display unit a predetermined amount of time after the first time, which predetermined time is greater than a time period required for the main processor to load an image file ready for display by the visual display unit. The image file may be loaded, for example, from a memory of the display device, or it may be received by the display device, for example from a server. The predetermined time may be determined in advance, for example by empirically testing how long the main processor requires to load an image file ready for display by the visual display unit, by incrementally increasing the length of time after the main processor is powered on before the visual display unit is powered on, until it is discovered that the image file appears on the visual display unit instantaneously, once the visual display unit has been powered on. This solution has the advantage that the image file is then displayed by the visual display unit as soon as it is powered on.

In some embodiments, at least some of the display devices may each further comprise one or more additional powered components, such as one or more of a loudspeaker, a sound processing unit for processing sounds for emission by the loudspeaker, a video processing unit for processing still and/or moving images for display by the visual display unit, a lighting unit for illuminating the visual display unit, and so on. In such a case, the method may further comprise powering on the additional powered components sequentially at respective times at or after the first time up to and including the later time. This solution has the advantage that power on of at least some of the display devices is thereby converted into a sequence of steps, each of which steps has associated with it a respective increase in the power consumed by the respective display devices, but which only increase the power consumed by much less than the total power consumption for the respective display device, thereby helping to spread the load placed on the power distribution network still further. Preferably, the same method can be applied to at least a majority of the display devices, and more preferably still, the same method can be applied to all of the display devices in the plurality of the display devices.

If the one or more additional powered components comprise a loudspeaker, a sound processing unit for processing sounds for emission by the loudspeaker, a video processing unit for processing still and/or moving images for display by the visual display unit and a lighting unit for illuminating the visual display unit, the method may further comprise powering on the sound processing unit and the video processing unit at the first time, powering on the loudspeaker at a time after the first time up to and including the later time, and powering on the lighting unit at or near to the later time. This solution has the advantage that the sound processing unit and the video processing unit can then respectively be ready to supply an audio signal to the loudspeaker and a video signal to the visual display unit as soon as the loudspeaker and the visual display unit are powered on, so that the still and/or moving images are displayed by the visual display unit as soon as it and the lighting unit are powered on, and that the loudspeaker is ready to emit any sound accompanying the still and/or moving images as soon as or even before the still and/or moving images commence.

The technique of the present invention may also be applied in reverse. Thus, the present invention also relates to a method of powering down a plurality of display devices, wherein each of the display devices at least comprises a main processor and a visual display unit under control of the main processor, the method at least comprising powering off the visual display units of respective ones of the plurality of display devices at respective third times, and powering off the main processors of the respective ones of the plurality of display devices at respective fourth times, each of which is later than the respective third time. Like the method of powering on a plurality of display devices described herein, this method of powering down a plurality of display devices has the advantage of reducing the load placed on a power distribution network by spreading the powering off of each one of the plurality of display devices over a finite period of time, thereby reducing the size of sudden changes in the total power drawn from the power distribution network, and the strain on the power distribution network.

In some embodiments, the respective fourth times may be substantially the same time as each other. Whereas powering off the main processors of all of the plurality of display devices at the same time as each other generates a larger reduction in power consumption than powering off the main processors of the display devices at different times from each other, since the main processor only consumes a small fraction of the total power consumed by each display device, the power distribution network is easily able to cope with them all being powered off together. On the other hand, this solution has the advantage that the plurality of display devices can be all powered off together.

In further embodiments, at least one of the display devices may further comprise one or more additional powered components. In such a case, the method may comprise powering off the additional powered components of the at least one of the display devices sequentially at respective times at or after the third time for said at least one of the display devices up to and including the fourth time for said at least one of the display devices. This solution has the advantage that power off of the at least one of the display devices is thereby converted into a sequence of steps, each of which steps has associated with it a respective reduction in the power consumed by the at least one of the display devices, thereby helping to reduce the load placed on the power distribution network more smoothly.

Preferably, a time period between the first time and the later time or between the third time and the fourth time lies in a range of from 100 seconds to 1000 seconds, more preferably between 200 seconds and 800 seconds, and more preferably still between 300 seconds and 600 seconds. Such time periods are successively more beneficial in striking a balance between smoothing out sudden changes in the load placed on the power distribution network on the one hand, and the need to carry out complete power-on or power-off of the plurality of display devices within a conveniently short time on the other hand.

The present invention further relates to a computer program product or a program code or system for executing one or more than one of the herein described methods.

The present invention also relates to a network comprising a plurality of display devices, wherein each of the display devices at least comprises a main processor and a visual display unit under control of the main processor, and a server connected in communication with each of the plurality of display devices, wherein the server is configured to power on the main processor of at least a majority of the display devices at a first time, and to power on the visual display unit of said majority of the display devices at a later time. Preferably, the server is configured to power on the main processor of all of the display devices at the same time as each other.

In some embodiments, the plurality of display devices and the server may be in two-way communication with each other, the main processor of each of the plurality of display devices may be configured to send a notification to the server after being powered on and booting up, that it has booted up, and the server may be configured to issue a command, following receipt of said notification, to the respective one of the display devices to power on the visual display unit thereof.

In other embodiments, the plurality of display devices and the server may be in two-way communication with each other, the main processor of at least one of the plurality of display devices may be configured to load an image file ready for display by the visual display unit thereof after being powered on and booting up, and to send a notification to the server that it has loaded the image file ready for display by the visual display unit thereof, and the server may be configured to issue a command, following receipt of said notification, to the respective one of the display devices to power on the visual display unit thereof. Preferably, the main processor of at least a majority of the display devices, and more preferably still, the main processor of all of the display devices in the plurality of the display devices is configured in such a fashion.

In some embodiments, the server may also be configured to issue commands to power off the visual display units of respective ones of the plurality of display devices at respective third times, and to power off the main processors of the respective ones of the plurality of display devices at respective fourth times, each of which is later than the respective third time.

Further features, goals and advantages of the present invention will now be described in association with the accompanying drawings, in which exemplary components of the invention are illustrated. Components of the devices and methods according to the invention which are at least essentially equivalent to each other with respect to their function can be marked by the same reference numerals, wherein such components do not have to be marked or described in all of the drawings.

In the following description, the invention is described by way of example only with respect to the accompanying drawings.

### BRIEF DESCRIPTION OF THE DRAWINGS

FIG. 1 is a graph schematically representing a prior art method of powering on a plurality of display devices;

FIG. 2 is a schematic block diagram of an embodiment of a network of display devices;

FIG. 3 is a schematic block diagram of an embodiment of a display device; and

FIG. 4 is a graph schematically representing an embodiment of a method of powering on a plurality of display devices.

### DETAILED DESCRIPTION OF THE DRAWINGS

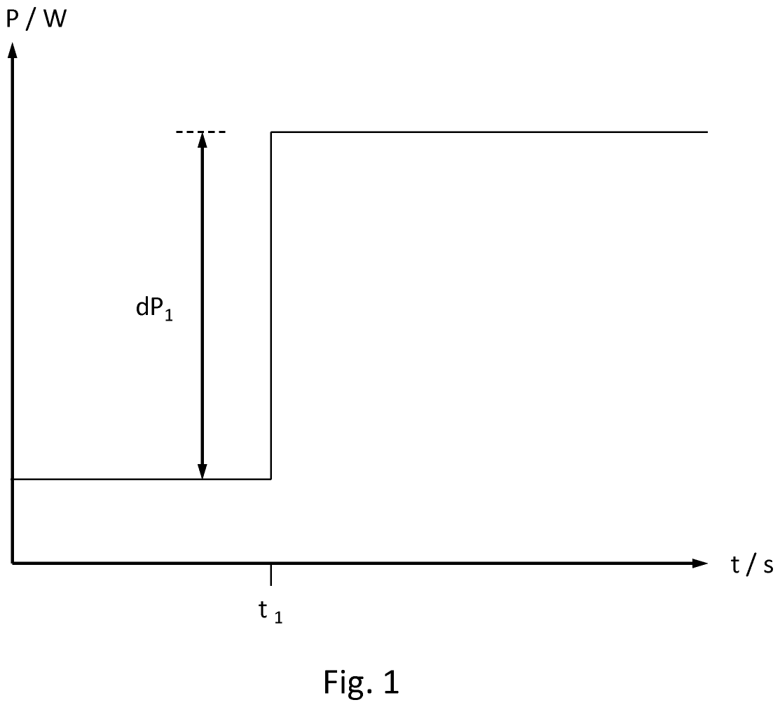

FIG. 1 schematically represents a prior art method of powering on a plurality of display devices. In the graph of FIG. 1, time measured in seconds is plotted on the x-axis or abscissa and power measured in watts is plotted on the y-axis or ordinate. According to this prior art method, the plurality of display devices are all powered on at time t₁, which causes a large increase in power consumption by the plurality of display devices, as indicated in FIG. 1 by dP₁. Such a large increase in power consumption as dPi₁places a strain on the power distribution network, which can have an undesirable knock-on effect on other loads attached to the same power distribution network.

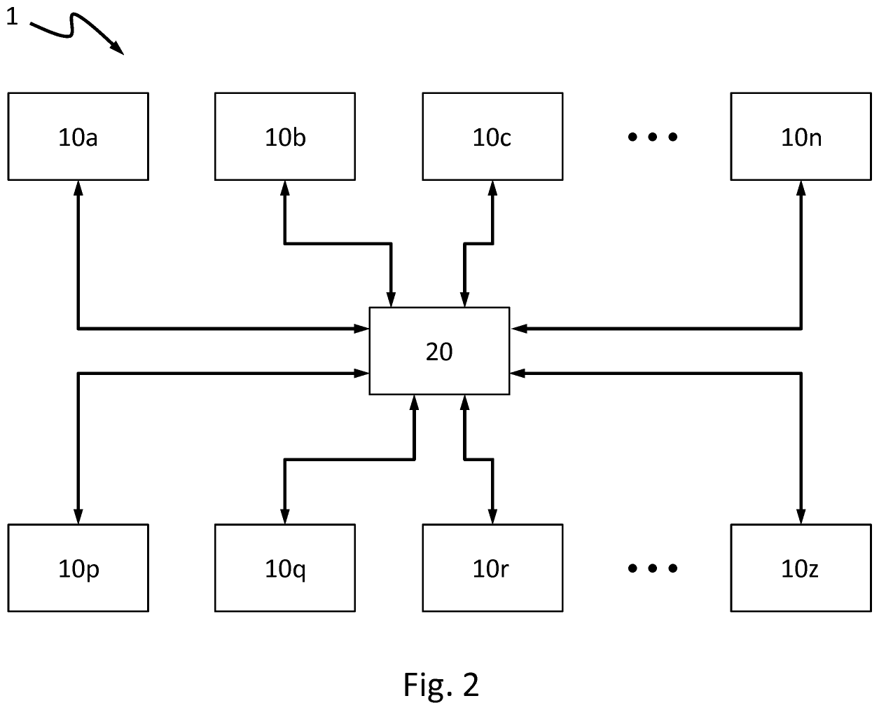

FIG. 2 schematically shows an embodiment of a network 1 of display devices 10. The network 1 comprises a plurality of display devices 10a, 10b, 10c, . . . 10n, . . . 10p, 10q, 10r, . . . 10z and a server 20. In the illustrated embodiment, the plurality of display devices 10a, 10b, 10c, . . . 10n, . . . 10p, 10q, 10r, . . . 10z are connected in two-way communication with the server 20. However, in other possible embodiments, the plurality of display devices may only be connected in one-way communication with the server 20, whereby the server can send commands to each of the display devices, but the plurality of display devices are only configured to receive and process such commands, but are unable to transmit information to the server. In the illustrated embodiment, the plurality of display devices 10a, 10b, 10c, . . . 10n, . . . 10p, 10q, 10r, . . . 10z are connected to the server 20 in a star-shaped configuration. However, in other possible embodiments, the plurality of display devices 10a, 10b, 10c, . . . 10n, . . . 10p, 10q, 10r, . . . 10z may instead be connected to the server 20 in one of several other possible configurations. For example, the plurality of display devices 10a, 10b, 10c, . . . 10n, . . . 10p, 10q, 10r, . . . 10z could instead be connected to the server 20 via a common bus.

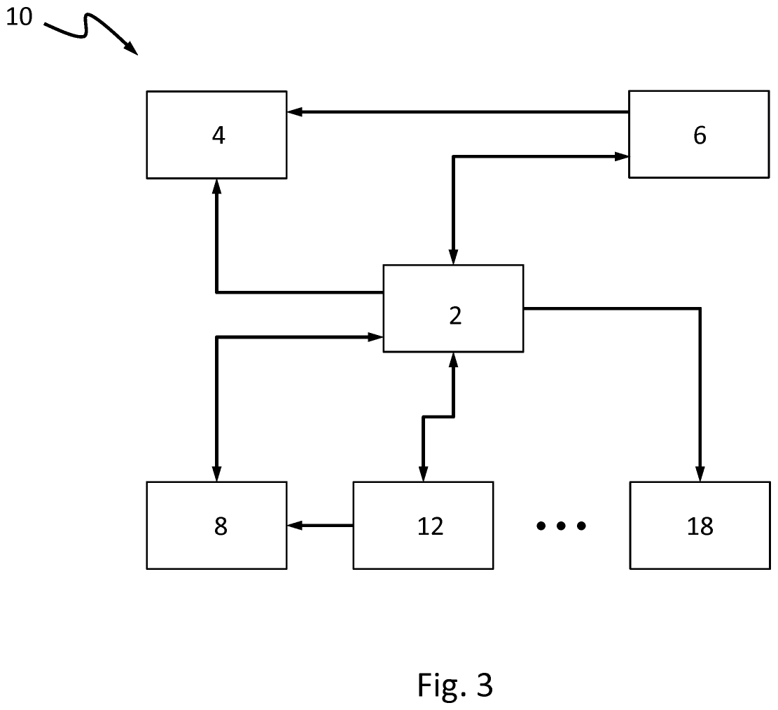

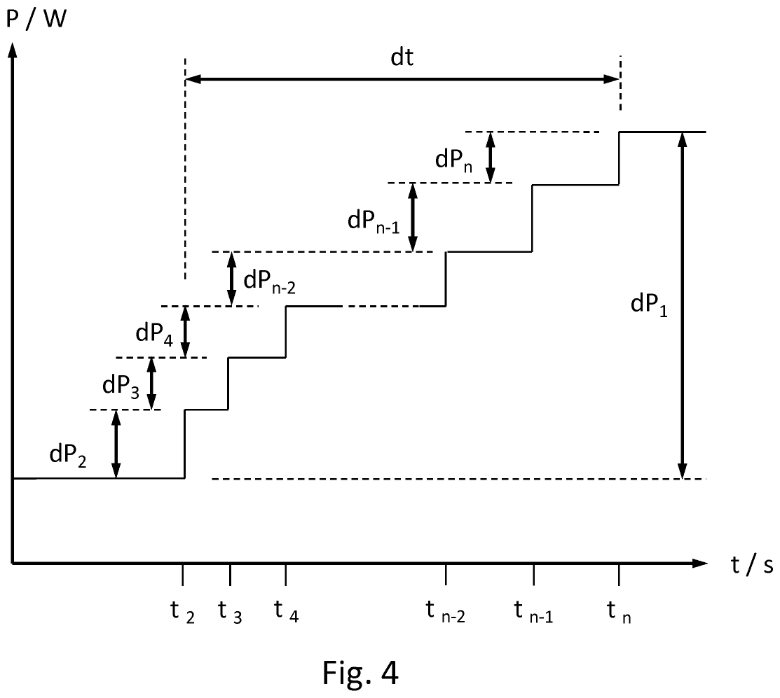

Each of the display devices 10a, 10b, 10c, . . . 10n, . . . 10p, 10q, 10r, . . . 10z at least comprises a main processor and a visual display unit, which will both be described in greater detail below in relation to FIG. 3. The server 20 is configured to power on the main processor of each of the display devices at a first time, and to power on the visual display unit of each of the display devices at a later time, in a manner, which will be described in greater detail below in relation to FIG. 4. The main processor of each of the display devices is configured to send a notification to the server 20 after being powered on and booting up, that it has booted up, and the server is configured to issue a command, following receipt of said notification, to the respective one of the display devices to power on the visual display unit thereof.

FIG. 3 schematically shows an exemplary embodiment of one of the display devices 10, such as those contained in the network 1 shown in FIG. 2. This exemplary embodiment of a display device 10 comprises a main processor 2, one or more loudspeakers 4, a sound processing unit 6 for processing sounds for emission by the one or more loudspeakers 4, a visual display unit 8, a video processing unit 12 for processing still and/or moving images for display by the visual display unit 8, and a lighting unit 18, such as a backlight, for illuminating the visual display unit 8. The main processor 2 controls the operation of the other components of the display device 10, either directly or via the sound processing unit 6 and the video processing unit 12, which are in two-way communication with the main processor 2.

The main processor 2 may, for example, comprise a central processing unit, which is mounted on a main circuit board of the display device 10. The central processing unit may comprise a single integrated circuit or a plurality of integrated circuits. The main circuit board may comprise further ancillary components mounted thereon, in addition to the central processing unit. For example, at least one of the sound processing unit 6 and the video processing unit 12 may also be mounted on the main circuit board of the display device 10. The visual display unit 8 may, for example, comprise an OLED display screen or a plasma display screen.

The display device 10 may also comprise one or more other components not represented in FIG. 3, such as a first power unit for powering the one or more loudspeakers 4, a second power unit for powering the lighting unit 18, a memory, a network communications module, a co-processor, and so on. On the other hand, whereas the exemplary embodiment of a display device 10 shown in FIG. 3 comprises both a loudspeaker 4 and a sound processing unit 6, in other possible embodiments, the display device 10 may not be sound-enabled, so that the components 4, 6 may be absent from such a device 10, which can therefore only display silent still and/or moving images.

FIG. 4 schematically represents an embodiment of a method of powering on a plurality of display devices, such as those shown in FIG. 2. In the graph of FIG. 4, time measured in seconds is again plotted on the x-axis or abscissa and power measured in watts is again plotted on the y-axis or ordinate. According to this method, only the main processors 2 of the plurality of display devices 10 are powered on at time t₂, which causes an increase in power consumption by the plurality of display devices, indicated in FIG. 4 by dP₂. As may be seen from FIG. 4, this increase in power consumption dP₂ is considerably less than the increase in power consumption dP₁ of the method of the prior art represented in FIG. 1. According to the embodiment of the method represented in FIG. 4, other components of the plurality of display devices 10, such as the one or more loudspeakers 4, the visual display unit 8, the lighting unit 18, and so on, are then powered on sequentially at subsequent times, t₃, t₄, . . . tₙ₋₂, tₙ₋₁ and tₙ. As may be seen from FIG. 4, these subsequent power-on events each cause a respective increase in power consumption dP₃, dP₄, . . . dPₙ₋₂, dPₙ₋₁, and dPₙ, each of which is also considerably less than the increase in power consumption dP₁ of the method of the prior art represented in FIG. 1. Thus the total increase in power consumption dPᵢ of each display device is spread over a finite period of time dt, which is in contrast to the step change represented by dP₁in the prior art method of FIG. 1. Moreover, the finite period of time dt over which the total increase in power consumption is spread is greater than a time period required for the main processor to load an image file ready for display by the visual display unit. Thus, as soon as the visual display unit is powered on at time tₙ, the image file is ready to be displayed by the visual display unit.

An embodiment of a method of powering down a plurality of display devices can have a similar appearance to the graph of FIG. 4, wherein the stepwise power-down operations of the various different components of each of the display devices are reversed in time, but the total fall in power consumption dP₁by each display device, and the finite period of time dt over which this fall in power consumption is spread, remain the same.

In summary, therefore, the present invention provides a method of powering on a plurality of display devices, wherein each of the display devices at least comprises a main processor and a visual display unit under control of the main processor. The main processor may, for example, comprise a central processing unit, which is mounted on a main circuit board of the display device. The method at least comprises powering on the main processors of at least a majority of the display devices at a first time, and powering on the visual display units of said majority of the display devices at a later time. The present invention also provides a method of powering down such a plurality of display devices by performing a similar sequence of operations in reverse temporal order, as well as a network comprising such a plurality of display devices and a server connected in communication with each of the plurality of display devices, wherein the server is configured to power the main processor of at least a majority of the display devices on or off at a different time from powering the visual display unit of the same display devices respectively on or off. These methods and such a network have the advantage of spreading the total change in electrical power consumed from a power distribution network over a finite period of time, thereby reducing the strain placed on the power distribution network.

Reference Numerals:

| | |
|---|---|
| 1 | Network |
| 2 | Main processor |
| 4 | Loudspeaker |
| 6 | Sound processing unit |
| 8 | Visual display unit |
| 10 | Display device |
| 12 | Video processing unit |
| 18 | Lighting unit |
| 20 | Server |

1. A method of powering on a plurality of display devices, wherein each of the display devices at least comprises a main processor and a visual display unit under control of the main processor, the method at least comprising:
powering on the main processors of at least a majority of the display devices at a first time (t₂); and
powering on the visual display units of said majority of the display devices at a time (tₙ), which is later than the first time (t₂).

2. A method according to claim 1, comprising:
powering on the main processor of all of the display devices at the first time (t₂); and
powering on the respective visual display units of the plurality of display devices at different respective times, each of which is later than the first time (t₂).

3. A method according to claim 1, further comprising after the first time (t₂) and before the later time (tₙ):
receiving a notification at a server (20) from at least one of the display devices that the main processor of the at least one of the display devices is booted up; and
issuing a command from the server (20) to the at least one of the display devices to power on the visual display unit of the at least one of the display devices.

4. A method according to claim 1, wherein the visual display unit is powered on a predetermined time (dt) after the first time (t₂), which predetermined time (dt) is greater than a time period required for the main processor to load an image file ready for display by the visual display unit.

5. A method according to claim 1, wherein at least some of the display devices each further comprises one or more additional powered components and the method further comprises:
powering on the additional powered components sequentially at respective times (t₃, t₄, . . . tₙ₋₂, tₙ₋₁) at or after the first time (t₂) up to and including the later time (tₙ).

6. A method according to claim 5, wherein the one or more additional powered components comprise a loudspeaker, a sound processing unit for processing sounds for emission by the loudspeaker, a video processing unit for processing still and/or moving images for display by the visual display unit and a lighting unit for illuminating the visual display unit, and the method further comprises:
powering on the sound processing unit and the video processing unit at the first time (t₂);
powering on the loudspeaker at a time after the first time (t₂) up to and including the later time (tₙ); and
powering on the lighting unit at or near to the later time (tₙ).

7. A method of powering down a plurality of display devices, wherein each of the display devices at least comprises a main processor and a visual display unit under control of the main processor, the method at least comprising:
powering off the visual display units of respective ones of the plurality of display devices at respective third times; and
powering off the main processors of the respective ones of the plurality of display devices at respective fourth times, each of which is later than the respective third time.

8. A method according to claim 7, wherein the respective fourth times are substantially the same time as each other.

9. A method according to claim 7, wherein at least one of the display devices further comprises one or more additional powered components and the method comprises:
powering off the additional powered components of the at least one of the display devices sequentially at respective times (t₃, t₄, . . . tₙ₋₂, tₙ₋₁) at or after the third time for said at least one of the display devices up to and including the fourth time for said at least one of the display devices.

10. A method according to claim 7, wherein a time period (dt) between the first time (t₂) and the later time (tₙ) or between the third time and the fourth time lies in a range of from 100 seconds to 1000 seconds.

11. (canceled)

12. A network comprising:
a plurality of display devices, wherein each of the display devices at least comprises a main processor and a visual display unit under control of the main processor; and
a server connected in communication with each of the plurality of display devices;
wherein the server is configured to power on the main processor of at least a majority of the display devices at a first time (t2), and to power on the visual display unit of said majority of the display devices at a later time (tₙ).

13. A network according to claim 12, wherein:
the plurality of display devices and the server are in two-way communication with each other;
the main processor of each of the plurality of display devices is configured to send a notification to the server after being powered on and booting up, that it has booted up; and
the server is configured to issue a command, following receipt of said notification, to the respective one of the display devices to power on the visual display unit thereof

14. A network according to claim 12 wherein:
the plurality of display devices and the server are in two-way communication with each other;
the main processor of at least one of the plurality of display devices is configured to load an image file ready for display by the visual display unit thereof after being powered on and booting up, and to send a notification to the server that it has loaded the image file ready for display by the visual display unit thereof; and
the server is configured to issue a command, following receipt of said notification, to the respective one of the display devices to power on the visual display unit thereof.

15. A network according to claim 12, wherein the server is configured to issue commands to:
power off the visual display units of respective ones of the plurality of display devices at at respective third times; and
power off the main processors of the respective ones of the plurality of display devices at respective fourth times, each of which is later than the respective third time.

16. A computer program product for powering on a plurality of display devices, wherein each of the display devices at least comprises a main processor and a visual display unit under control of the main processor, the computer program product comprising instructions for:
powering on the main processors of at least a majority of the display devices at a first time (t₂); and
powering on the visual display units of said majority of the display devices at a time (tₙ), which is later than the first time (t₂).

17. A computer program product according to claim 16, further comprising instructions for:
powering on the main processor of all of the display devices at the first time (t₂); and
powering on the respective visual display units of the plurality of display devices at different respective times, each of which is later than the first time (t₂).

18. A computer program product according to claim 16, further comprising instructions for, after the first time (t₂) and before the later time (tₙ):
receiving a notification at a server (20) from at least one of the display devices that the main processor of the at least one of the display devices is booted up; and
issuing a command from the server (20) to the at least one of the display devices to power on the visual display unit of the at least one of the display devices.

19. A computer program product according to claim 16, wherein the visual display unit is powered on a predetermined time (dt) after the first time (t₂), which predetermined time (dt) is greater than a time period required for the main processor to load an image file ready for display by the visual display unit.

20. A computer program product according claim 16, wherein at least some of the display devices each further comprises one or more additional powered components, and further comprising instructions for:
powering on the additional powered components sequentially at respective times (t₃, t₄, . . . tₙ₋₂, tₙ₋₁) at or after the first time (t₂) up to and including the later time (tₙ).

21. A computer program product according to claim 16, wherein the one or more additional powered components comprise a loudspeaker, a sound processing unit for processing sounds for emission by the loudspeaker, a video processing unit for processing still and/or moving images for display by the visual display unit and a lighting unit for illuminating the visual display unit, and further comprising instructions for:
powering on the sound processing unit and the video processing unit at the first time (t₂);
powering on the loudspeaker at a time after the first time (t₂) up to and including the later time (tₙ); and
powering on the lighting unit at or near to the later time (tₙ).

22. A computer program product for powering down a plurality of display devices, wherein each of the display devices at least comprises a main processor and a visual display unit under control of the main processor, and further comprising instructions for:
powering off the visual display units of respective ones of the plurality of display devices at respective third times; and
powering off the main processors of the respective ones of the plurality of display devices at respective fourth times, each of which is later than the respective third time.

23. A computer program product according to claim 22, wherein the respective fourth times are substantially the same time as each other.

24. A computer program product according to claim 22, wherein at least one of the display devices further comprises one or more additional powered components and further comprising instructions for:
powering off the additional powered components of the at least one of the display devices sequentially at respective times (t₃, t₄, . . . tₙ₋₂, tₙ₋₁) at or after the third time for said at least one of the display devices up to and including the fourth time for said at least one of the display devices.

25. A computer program product according claim 22, wherein a time period (dt) between the first time (t₂) and the later time (tₙ) or between the third time and the fourth time lies in a range of from 100 seconds to 1000 seconds.
